(19) United States
(12) Patent Application Publication
(10) Pub. No.: US 2025/0295117 A1
(43) Pub. Date: Sep. 25, 2025

(54) PEST CONTROL COMPOSITIONS

(71) Applicants: Dow Global Technologies LLC, Midland, MI (US); Rohm and Haas Company, Collegeville, PA (US)

(72) Inventors: Caroline Woelfle-Gupta, Midland, MI (US); Selvanathan Arumugam, West Chester, PA (US); Daniel A. Saucy, Harleysville, PA (US); Susan L. Jordan, Doylestown, PA (US); Yujing Tan, Midland, MI (US)

(21) Appl. No.: 18/863,096

(22) PCT Filed: May 31, 2022
(86) PCT No.: PCT/US2022/031533

§ 371 Date: Nov. 5, 2024

(51) Int. Cl. A01N 63/23; A01N 25/10; A01P 7/04

(52) U.S. Cl. CPC A01N 63/23; A01N 25/10; A01P 7/04

(57) ABSTRACT

A pest control composition includes a polymer. wherein the polymer has a weight average molecular weight from 15,000 daltons to 30,000 daltons and contains from 50 wt % to 70 wt % of monomeric structural units derived from a monomer with a log P of from 2.0 to 6.0; bacillus thuringiensis: and water.

### FIELD OF DISCLOSURE

The present disclosure is generally related to pest control compositions, and more specifically pest control compositions comprising bacillus thuringiensis.

### BACKGROUND

Pest control agents are utilized to control pests, such as insects. The effectiveness of pest control agents can be influenced by a number of factors. There is continued focus in the industry on developing new and improved pest control compositions.

### SUMMARY

According to a first feature of the present disclosure, a pest control composition comprises a polymer, wherein the polymer has a weight average molecular weight from 15,000 daltons to 30,000 daltons and contains from 50 wt % to 70 wt % of monomeric structural units derived from a monomer with a log P of from 2.0 to 6.0; bacillus thuringiensis; and water. According to a second feature, the polymer is from 0.10 wt % to 20.00 wt % of the composition based upon a total weight of a combination of the polymer, the bacillus thuringiensis, and the water. According to a third feature, the water is from 60.00 wt % to 99.89 wt % of the composition based upon the total weight of the combination of the polymer the bacillus thuringiensis, and the water. According to a fourth feature, the polymer contains from 50 wt % to 70 wt % of monomeric structural units derived from a monomer with log P of from 2.75 to 4.08. According to a fifth feature, the polymer contains 90 wt % or greater of monomeric structural units derived from a monomer with log P of 1.0 or greater. According to a sixth feature, the polymer comprises one or more of (i) a copolymer of diisobutylene and maleic anhydride, (ii) a copolymer of butyl methacrylate and methacrylic acid and (iii) combinations thereof.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Subscript values in polymer formulae refer to mole average values for the designated component in the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Pest control compositions are disclosed herein. Embodiments of the present disclosure provide that the pest control compositions include a polymer and bacillus thuringiensis.

The pest control compositions disclosed herein may be applied to plants, e.g., plant surfaces, to control pests. Advantageously, the pest control compositions disclosed herein can provide improved, i.e., greater, residual protein concentrations for bacillus thuringiensis following exposure to rain, as compared to other formulations. The improved residual protein concentrations indicate that the pest control compositions disclosed herein can provide improved pest control, as compared to other formulations.

Further, the pest control compositions disclosed herein can provide a percentage of bacillus thuringiensis activity retained greater than 80% following exposure to rain. Providing the percentage of bacillus thuringiensis activity retained greater than 80% can indicate a desirable degree of rainfastness.

The pest control compositions disclosed herein can include a polymer. As used herein, “a” refers to one or more unless indicated otherwise. As used herein a “polymer” has two or more of the same or different monomeric structural units derived from two or more different monomers, e.g., copolymers, terpolymers, etc. “Monomeric structural unit”, as used herein in reference to polymers, indicates a portion of the polymer structure that results from a reaction of a monomer or monomers to form the polymer. “Different” in reference to monomeric structural units indicates that the monomeric structural units differ from each other by at least one atom or are different isomerically. Embodiments of the present disclosure provide that the monomeric structural units of the polymer result, i.e. are formed, from a polymerization reaction of the monomers. One or more embodiments provide that a monomeric structural unit may undergo one or more reactions subsequent to the polymerization reaction, e.g., a hydrolysis reaction.

Embodiments of the present disclosure provide that the polymer contains from 50 wt % to 70 wt % of monomeric structural units derived from a monomer, i.e. one or more monomers, with log P of from 2.0 to 6.0, based upon a total weight of the polymer. The polymer may contain greater than 90 wt % of monomeric structural units derived from a monomer with log P of greater than 1.0.

One or more of the monomeric structural units may have a log P of 1.0 or greater, or 1.2 or greater, or 1.4 or greater, or 1.6 or greater, or 1.8 or greater, or 2.0 or greater, or 2.2 or greater, or 2.4 or greater, or 2.6 or greater, or 2.8 or greater, or 3.0 or greater, or 3.2 or greater, or 3.4 or greater, or 3.6 or greater, or 3.8 or greater, or 4.0 or greater, or 4.2 or greater, or 4.4 or greater, or 4.6 or greater, or 4.8 or greater, or 5.0 or greater, or 5.2 or greater, or 5.4 or greater, or 5.6 or greater, or 5.8 or greater, while at the same time, 6.0 or less, or 5.8 or less, or 5.6 or less, or 5.4 or less, or 5.2 or less, or 5.0 or less, or 4.8 or less. or 4.6 or less, or 4.4 or less, or 4.2 or less, or 4.0 or less, or 3.8 or less. or 3.6 or less, or 3.4 or less, or 3.2 or less, or 3.0 or less, or 2.8 or less. or 2.6 or less, or 2.4 or less, or 2.2 or less, or 2.0 or less, or 1.8 or less. or 1.6 or less, or 1.4 or less, or 1.2 or less. Log P values are determined by utilizing the Estimation Programs Interface (EPI) Suite™, (KOWWIN version 1.68) available at https://www.epa.gov/tsca-screening-tools/epi-suitetm-estimation-program-interface.

Exemplary monomers for use in the polymer include, but are not limited to, diisobutylene (log P of 4.08), butyl methacrylate (log P of 2.75), butyl acrylate (log P of 2.20), methyl methacrylate (log P of 1.28), ethyl acrylate (log P of 1.22), 2-ethylehexyl acrylate (log P of 4.09), styrene (log P of 2.89), maleic anhydride (log P of 1.62), docosyl methacrylate (log P of 11.59), and combinations thereof.

As mentioned, the polymer may contain from 20 wt % to 100 wt % of monomeric structural units derived from a monomer with log P from 2.0 to 6.0. For example, the polymer may contain 52 wt % or greater, or 54 wt % or greater, or 56 wt % or greater, or 58 wt % or greater, or 60 wt % or greater, or 62 wt % or greater, or 64 wt % or greater, or 66 wt % or greater, or 68 wt % or greater, while at the same time, 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less of a monomer with log P of from 2.0 to 6.0.

As mentioned, the polymer may contain 90 wt % of monomeric structural units derived from a monomer with log P of greater than or equal to 1.0. For example, the polymer may contain 91 wt % or greater, or 92 wt % or greater, or 93 wt % or greater, or 94 wt % or greater, or 95 wt % or greater, or 96 wt % or greater, or 97 wt % or greater, or 98 wt % or greater, or 99 wt % or greater, while at the same time, 100 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less of a monomer with log P of 1.0 or greater based on the total weight of the polymer.

The polymer may comprise structural units from one or more of itaconic acid, fumaric acid, crotonic acid, acrylic acid, methacrylic acid, maleic acid, acryloxypropionic acid, citraconic acid, methyl acrylate, vinyl acetate, and combinations thereof.

Embodiments of the present disclosure provide that the polymer has a weight average molecular weight from 15,000 daltons to 30,000 daltons. For example, the polymer may have a weight average molecular weight of 15,000 daltons or greater, or 16,000 daltons or greater, or 17,000 daltons or greater, or 18,000 daltons or greater, or 19,000 daltons or greater, or 20,000 daltons or greater, or 21,000 daltons or greater, or 22,000 daltons or greater, or 23,000 daltons or greater, or 24,000 daltons or greater, or 25,000 daltons or greater, or 26,000 daltons or greater, or 27,000 daltons or greater, or 28,000 daltons or greater, or 29,000 daltons or greater, while at the same time, 30,000 daltons or less, or 29,000 daltons or less, or 28,000 daltons or less, or 27,000 daltons or less, or 26,000 daltons or less, or 25,000 daltons or less, or 24,000 daltons or less, or 23,000 daltons or less, or 22,000 daltons or less, or 21,000 daltons or less, or 20,000 daltons or less, or 19,000 daltons or less, or 18,000 daltons or less, or 17,000 daltons or less, or 16,000 daltons or less. The weight average molecular weight of the polymer is determined using gel permeation chromatography.

The polymer can be prepared using known equipment, reaction components, and reaction conditions. For instance, the polymer can be prepared by known polymerization, e.g., solution polymerization. The solution polymerization of monomers, i.e., monomers discussed herein, can be performed in a non-aqueous solvent, for instance. Suitable solvents include, but are not limited to, toluene, xylenes, propylene glycol, methylethylketone, and combinations thereof. The solution polymerization can include a solvent-soluble initiator. Examples of the initiator include, but are not limited to,

t-butylperoctoate, t-butylhydroperoxide, AIBN, 2,2-azobis (2,4-dimethyl-pentanenitrile), t-butylperoxybenzoate, and combinations thereof. The initiator may be used from 0.01 wt % to 1.00 wt %, based on a total weight of monomers utilized in the solution polymerization, for instance. The solution polymerization may utilize a chain transfer agent. Examples of the chain transfer agent include, but are not limited to, 2-mercaptoethanol, 3-methylmercaptopropionic acid, n-dodecylmercaptan, t-dodecylmercaptan, and combinations thereof. The chain transfer agent may be used from 0.01 wt % to 5.00 wt %, based on a total weight of monomers utilized in the solution polymerization, for instance. The use of a mercaptan modifier may reduce the molecular weight of the polymer. Other known components may be utilized for the solution polymerization; different amount of these other known components may be utilized for various applications.

The polymer can be prepared by known polymerization, e.g., emulsion polymerization. The emulsion polymerization may utilize a surfactant. Examples of surfactants include, but are not limited to, anionic surfactants such as sodium laurylsulfate, sodium dodecylbenzenesulfonate, and sodium ethoxylated [C10] alcohol half-ester of sulfosuccinic acid, and combinations thereof. The surfactant may be used from 0.5 wt % to 6.0 wt %, based on a total weight of monomers utilized in the emulsion polymerization, for instance. The emulsion polymerization may utilize an initiator, such as a water-soluble initiator, for instance. Examples of initiators include, but are not limited to, alkali metal persulfates, ammonium persulfate, and combinations thereof. The initiator may be utilized from 0.01 wt % to 1.00 wt %, based on a total weight of monomers utilized in the emulsion polymerization. The emulsion polymerization may utilize a chain transfer mercaptan. Examples of chain transfer mercaptans include, but are not limited to, 2-mercaptopropionic acid, 3-methylmercaptopropionic acid, alkyl mercaptans containing from 4 to 20 carbon atoms, and combinations thereof. The chain transfer mercaptan may be utilized from

0.01 wt % to 5.00 wt % based on a total weight of monomers utilized in the emulsion polymerization. The use of mercaptan modifier may reduce the molecular weight of the polymer. Other known components may be utilized for the emulsion polymerization; different amount of these other known components may be utilized for various applications.

The polymer may be obtained commercially under various tradenames.

As mentioned, a monomeric structural unit of the polymer described herein may undergo one or more reactions subsequent to the polymerization reaction, e.g., a hydrolysis reaction. The hydrolysis reaction can include the hydrolysis of an ester to an acid or the ring-opening of an anhydride to an acid, for example.

The pest control compositions disclosed herein comprise bacillus thuringiensis. As defined herein, “bacillus thuringiensis” is the spores and/or the crystallized proteins of the species bacillus thuringiensis and includes all bacillus thuringiensis subspecies exhibiting insecticidal properties. Examples of such subspecies include kurstaki, israelensis and aizawa. The bacillus thuringiensis may be added to the pesticide formulation as either a solid or as part of a liquid formulation. The presence and subspecies of bacillus thuringiensis is determined by Random Amplified Polymorphic DNA analysis. A commercially available liquid formulation of bacillus thuringiensis is THURICIDE™ pesticide available from CERTIS USA, Columbia, Maryland.

The pest control compositions disclosed herein can include water. One or more embodiments of the present disclosure provide that the pest control composition is a solution, i.e., the polymer and the bacillus thuringiensis are water soluble. Advantageously, the pest control compositions disclosed herein may overcome a number of issues, e.g., utilize fewer components, such as surfactants, that are utilized with emulsions and/or dispersions, and/or redispersible polymers. Different amounts of water may be utilized for various applications.

One or more embodiments of the present disclosure provide that the pest control compositions disclosed herein can include an additive. Examples of additives include viscosity modifiers, pH modifiers, herbicides, fungicides, and combinations thereof, among others. Different amount of the additive may be utilized for various applications.

The pest control compositions disclosed herein can include from 0.10 wt % to 20.00 wt % of the polymer, based upon a total weight of a combination of the polymer, the bacillus thuringiensis, and the water. All individual values and subranges from 0.10 wt % to 20.00 wt % are included; for example, the pest control composition can include the polymer from a lower limit of 0.10 wt %, 0.15 wt %, 0.20 wt %, 0.25 wt %, or 0.30 wt % to an upper limit of 20.00 wt %, 15.00 wt %, 10.00 wt %, 9.00 wt %, or 8.00 wt % based upon the total weight of the combination of the polymer, the bacillus thuringiensis, and the water.

The pest control compositions disclosed herein can include from 0.01 wt % to 20.00 wt % of the bacillus thuringiensis, based upon a total weight of a combination of the polymer, the bacillus thuringiensis, and the water. All individual values and subranges from 0.01 wt % to 20.00 wt % are included; for example, the pest control composition can include the bacillus thuringiensis from a lower limit of 0.01 wt %, 0.02 wt %, 0.03 wt %, 0.04 wt %, or 0.05 wt % to an upper limit of 20.00 wt %, 15.00 wt %, 10.00 wt %, 7.50 wt %, 5.00 wt %, 4.75 wt %, or 4.50 wt % based upon the total weight of the combination of the polymer, the bacillus thuringiensis, and the water.

The pest control compositions disclosed herein can include from 60.00 wt % to 99.89 wt % of water, based upon a total weight of a combination of the polymer, the bacillus thuringiensis, and the water. All individual values and subranges from 60.00 wt % to 99.89 wt % are included; for example, the pest control composition can include the water from a lower limit of 60.00 wt %, 65.00 wt %, 70.00 wt %, 75.00 wt %, or 80.00 wt % to an upper limit of 99.89 wt %, 99.80 wt %, 99.00 wt %, 98.00 wt % or 95.00 wt % based upon the total weight of the combination of the polymer, the bacillus thuringiensis, and the water.

The pest control compositions disclosed herein can be formed using known equipment and processes. The components of the pest control compositions may be combined, e.g., mixed, to form the pest control compositions. For instance, the components of the pest control compositions may be added to a vessel and be agitated therein. The components of the pest control compositions may be combined in any order.

The pest control compositions disclosed herein may be applied to plants, e.g., plant surfaces, to control pests. The pest control compositions may be applied to plants using known equipment and processes. For instance, the pest control compositions may be sprayed, sprinkled, and/or poured, among other applications, to plants. Different amounts of the pest control composition may be applied to plants for various applications.

### EXAMPLES

In the Examples, various terms and designations for materials are used including, for instance, the following:

BOND MAX™ (spreader/sticker, obtained from Loveland Products); DIPEL™ PRO DF (dry formulation, bacillus thuringiensis, manufactured by Valent Biosciences); THURICIDE™ (liquid formulation, bacillus thuringiensis, manufactured by Certis); NU FILM 17™ (sticking-extending adjuvant, obtained from Miller Chemical & Fertilizer Corporation); NU FILM P™ (sticking-extending adjuvant, obtained from Miller Chemical & Fertilizer Corporation); AD-HERE SP™ (deposition aid, obtained from J.R. Simplot Company); spreader/sticker (polymeric terpene including terpene resins, tall oil fatty acids, and alkylphenol ethoxylate; CAS Reg. No. 48813-50017-AA.); poly acrylic acid-1 (hydrophilic dispersant, sodium neutralized, weight average molecular weight of 5,100 daltons, CAS Reg No. 9003-04-7, obtained from SIGMA-ALDRICH™), poly acrylic acid-2 (hydrophilic dispersant, acidic, weight average molecular weight of 250,000 daltons, CAS Reg No. 9003-01-04, obtained from SIGMA-ALDRICH™), poly acrylic acid-3 (hydrophilic dispersant, ammonium neutralized, weight average molecular weight of 5,000 daltons, CAS Reg No. 9003-01-4, obtained from Polysciences, Inc.), poly acrylic acid-4 (hydrophilic dispersant, ammonium neutralized, weight average molecular weight of 250,000 daltons, CAS Reg No. 9003-01-4, obtained from SIGMA-ALDRICH™).

Polymer-1 was formed as follows. A solution polymerization was utilized to form a copolymer derived from diisobutylene and maleic anhydride. The wt % of polymer-1 formed from monomeric structural units of diisobutylene is from 45 wt % to 55 wt % with the remainder being maleic anhydride. The polymer was hydrolyzed with aqueous ammonia to provide Polymer-1. Polymer-1 had a weight average molecular weight of approximately 16,500 daltons.

Polymer-2 was formed as follows. A solution polymerization was utilized to form a random copolymer having approximately 60 wt % to 70 wt % of monomeric structural units derived from butyl methacrylate and approximately 30 wt % to 40 wt % of monomeric structural units derived from methacrylic acid. Polymer-2 was neutralized using ammonia to form an ammonia salt of an acrylic copolymer and had a weight average molecular weight of approximately 27,000 daltons.

Polymer-3 was formed as follows. An emulsion polymerization was utilized to form a polymer having approximately 60 wt % to 70 wt % of monomeric structural units derived from butyl methacrylate and approximately 30 wt % to 40 wt % of monomeric structural units derived from methacrylic acid. Polymer-3 had a weight average molecular weight of approximately 15,000 daltons.

Example 1, a pest control composition, was formed as follows. Polymer-1 was diluted with deionized water to provide a solution (5 wt % of Polymer-1 in water). The solution (2 mL), DIPEL™ PRO DF (2 grams), and water (16 grams) were combined and mixed with a magnetic stir bar to provide Example 1.

Example 2, a pest control composition, was formed as Example 1 with the change that Polymer-2 was utilized rather than the Polymer-1.

Example 3, a pest control composition, was formed as Example 1 with the change that Polymer-3 was utilized rather than the Polymer-1.

Comparative Example A was formed as Example 1 with the change that BOND MAX™ was utilized rather than the Polymer-1.

Comparative Example B was formed as Example 1 with the change that the Polymer-1 was not utilized.

Residual protein concentrations and bacillus thuringiensis activities for Examples 1-3 and Comparative Examples A-B were determined as follows.

Examples 1-3 and Comparative Examples A-B were each diluted with water to provide a concentration of 2.5 grams of bacillus thuringiensis per liter. Pieces of parafilm (2 inches by 4 inches) were respectively placed on a black Leneta card and a Kimwipe was gently rubbed over the parafilm before removing the parafilm paper. An auto-pipettor was used to randomly place 15 drops (15-30 μL) of Examples 1-3 and Comparative Examples A-B in an array on the respective parafilms, one parafilm for each Example/Comparative Example was utilized; the samples were vortex mixed between each set of 5 drops to maintain composition consistency. Then, the parafilms were dried in an incubator at approximately 28° C. for approximately 1 hour.

The dried parafilms were then subjected to simulated rain as follows. Each dried parafilm was respectively placed in an Exo Terra Monsoon RS400 Rainfall System (fitted with 2 Exo Terra standard nozzles without any extensions); the parafilm was 13 inches from the spray nozzle. Water was sprayed onto the parafilm at a flow rate of 1.5 liters/hour, measured at the substrate interface, for 5 minutes; after which the parafilm was allowed to dry.

Following exposure to the simulated rain, the samples were extracted. For extraction, each of the respective parafilms was cut such that each dot, resultant from the drops, was centered on an approximately 0.25-inch square. For each respective parafilm, all of the cut, dotted squares were placed into a glass vial to which a Sodium Dodecyl Sulfate solution (1 milliliter, 2 wt % sodium dodecyl sulfate in water) was added. Each glass vial was then sonicated and left to soak for approximately 8 hours. Sonication was repeated three times for the extractions.

Residual protein concentrations were determined by the bicinchoninic acid assay (BCA) as follows.

PIERCE™ BCA Protein Assay Reagent A and PIERCE™ BCA Protein Assay Reagent B (both obtained from THERMO SCIENTIFIC™) were combined Reagent A (2 milliliters) and Reagent B (40 microliters) to form a reagent mixture.

One hundred (100) microliters of each extracted sample (extracted Examples 1-3 and Comparative Examples A-B) was placed into a respective cuvette; then the reagent mixture (2 milliliters) was added to each cuvette; and then the cuvettes were incubated at 30° C. for approximately 2 hours. Absorption values at 562 nm measured with a Cary 100 UV-Visible Spectrophotometer were used to determine the residual protein concentrations. The residual protein concentration (i.e., the wt % of remaining active protein after simulated rain) results are reported in Table 1.

TABLE 1

| Example | (wt %) |
|---|---|
| Example 1 | 47 ± 3 |
| Example 2 | 45 ± 2 |
| Example 3 | 6 ± 1 |
| Comparative Example A | 0 |
| Comparative Example B | 0 |

The data of Table 1 illustrates that each of Examples 1-3 has an improved, i.e., greater, residual protein concentration as compared to Comparative Examples A-B.

The solutions, as extracted above, for Examples 1-3 and Comparative Examples A-B were diluted to a desired starting concentration, using a 0.1 wt % solution of TWEEN® 20 then then serially diluted at suitable concentrations and plated. The resultant bacillus thuringiensis activities are reported in Table 2.

TABLE 2

| | Before | After | Activity |
|---|---|---|---|
| | simulated rain | simulated rain | retained |
| Example | (CFU/mL) | (CFU/mL) | (percent) |
| Example 1 | 10.48 ± 0.08 | 10.34 ± 0.11 | 99 |
| Example 2 | 10.63 ± 0.10 | 10.48 ± 0.10 | 99 |
| Example 3 | 10.50 ± 0.12 | 8.77 ± 0.15 | 84 |
| Comparative | 10.59 ± 0.06 | 8.41 ± 0.11 | 79 |
| Example A | | | |
| Comparative | 10.76 ± 0.12 | 8.65 ± 0.13 | 80 |
| Example B | | | |

The data of Table 2 illustrates that each of Examples 1-3 had a percentage of bacillus thuringiensis activity retained greater than 80%.

Example 4, a pest control composition, was formed as follows. Polymer-1 was diluted with deionized water to provide a solution (5 wt % of Polymer-1 in water). The solution (1 mL). THURICIDE™ (2 grams), and water (17 grams) were combined and mixed with a magnetic stir bar to provide Example 4.

Example 5, a pest control composition, was formed as Example 4 with the change that Polymer-2 was utilized rather than the Polymer-1.

Example 6, a pest control composition, was formed as Example 4 with the change that Polymer-3 was utilized rather than the Polymer-1.

Comparative Example C was formed as Example 4 with the change that NU FILM 17™ was utilized rather than the Polymer-1.

Comparative Example D was formed as Example 4 with the change that NU FILM P™ was utilized rather than the Polymer-1.

Comparative Example E was formed as Example 4 with the change that AD-HERE SP™ was utilized rather than the Polymer-1.

Comparative Example F was formed as Example 4 with the change that spreader/sticker (polymeric terpene) was utilized rather than the Polymer-1.

Comparative Example G was formed as Example 4 with the change that the Polymer-1 was not utilized.

Comparative Example H was formed as Example 4 with the change that poly acrylic acid-1 was utilized rather than the Polymer-1.

Comparative Example I was formed as Example 4 with the change that poly acrylic acid-2 was utilized rather than the Polymer-1.

Comparative Example J was formed as Example 4 with the change that poly acrylic acid-3 was utilized rather than the Polymer-1.

Comparative Example K was formed as Example 4 with the change that poly acrylic acid-4 was utilized rather than the Polymer-1.

Examples 4-6 and Comparative Examples C-K were each diluted with water to provide a concentration of 71 grams of bacillus thuringiensis per liter. Pieces of parafilm (2 inches by 4 inches) were respectively placed on a black Leneta card and a Kimwipe was gently rubbed over the parafilm before removing the parafilm paper. An auto-pipettor was used to randomly place 15 drops (15-30 μL) of Examples 4-6 and Comparative Examples C-K in an array on the respective parafilms, one parafilm for each Example/Comparative Example was utilized; the samples were vortex mixed between each set of 5 drops to maintain composition consistency. Then, the parafilms were dried in an incubator at approximately 28° C. for approximately 1 hour. Residual protein concentrations and bacillus thuringiensis activities were determined for Examples 4-6 and Comparative Examples C-K as previously discussed. The residual protein concentration (i.e., the wt % of remaining active protein after simulated rain) results are reported in Table 3 and the bacillus thuringiensis activity is reported in Table 4.

TABLE 3

| | Residual protein concentration |
|---|---|
| | (Wt % of remaining active protein |
| Example | after simulated rain) |
| Example 4 | 74 ± 2 |
| Example 5 | 71 ± 3 |
| Example 6 | 45 |
| Comparative Example C | 28 ± 2 |
| Comparative Example D | 36 ± 1 |
| Comparative Example E | 22 ± 3 |
| Comparative Example F | 38 ± 2 |
| Comparative Example G | 0 |
| Comparative Example H | 0 |
| Comparative Example I | 0 |
| Comparative Example J | 0 |
| Comparative Example K | 0 |

The data of Table 3 illustrates that each of Examples 4-6 had an improved. i.e., greater, residual protein concentration as compared to each of Comparative Examples C-K.

TABLE 4

| | Before | After | Activity |
|---|---|---|---|
| | simulated rain | simulated rain | retained |
| | (CFU/mL) | (CFU/mL) | (%) |
| Example 4 | 8.15 ± 0.13 | 8.23 ± 0.13 | 100 |
| Example 5 | 8.05 ± 0.12 | 7.62 ± 0.09 | 95 |
| Example 6 | 7.61 ± 0.10 | 7.96 ± 0.11 | 100 |
| Comparative | 8.37 ± 0.08 | 7.84 ± 0.12 | 94 |
| Example C | | | |
| Comparative | 8.38 ± 0.12 | 8.19 ± 0.10 | 98 |
| Example D | | | |
| Comparative | 8.23 + 0.13 | 7.92 + 0.08 | 96 |
| Example E | | | |
| Comparative | 8.31 + 0.11 | 7.76 + 0.10 | 93 |
| Example F | | | |
| Comparative | 8.57 + 0.13 | 5.53 + 0.10 | 65 |
| Example G | | | |
| Comparative | 8.01 + 0.12 | 5.26 + 0.11 | 66 |
| Example H | | | |
| Comparative | 8.79 + 0.11 | 5.42 + 0.10 | 62 |
| Example I | | | |
| Comparative | 7.91 + 0.10 | 4.79 + 0.12 | 61 |
| Example J | | | |
| Comparative | 8.17 + 0.09 | 5.02 + 0.13 | 62 |
| Example K | | | |

The data of Table 4 illustrates that each of Examples 4-6 had a percentage of bacillus thuringiensis activity retained greater than 80%.

1. A pest control composition comprising:
a polymer, wherein the polymer has a weight average molecular weight from 15,000 daltons to 30,000 daltons and contains from 50 wt % to 70 wt % of monomeric structural units derived from a monomer with a log P of from 2.0 to 6.0;
bacillus thuringiensis; and
water.

2. The pest control composition of claim 1, wherein the polymer is from 0.10 wt % to 20.00 wt % of the composition based upon a total weight of a combination of the polymer, the bacillus thuringiensis, and the water.

3. The pest control composition of one of claim 1, wherein the water is from 60.00 wt % to 99.89 wt % of the composition based upon the total weight of the combination of the polymer the bacillus thuringiensis, and the water.

4. The pest control composition of any one of claim 1, wherein the polymer contains from 50 wt % to 70 wt % of monomeric structural units derived from a monomer with log P of from 2.75 to 4.08.

5. The pest control composition of any one of claim 1, wherein the polymer contains 90 wt % or greater of monomeric structural units derived from a monomer with log P of 1.0 or greater.

6. The pest control composition of any of claim 1, wherein the polymer comprises one or more of (i) a copolymer of diisobutylene and maleic anhydride, (ii) a copolymer of butyl methacrylate and methacrylic acid and (iii) combinations thereof.
